(19) United States
(12) Patent Application Publication
(10) Pub. No.: US 2017/0043882 A1
(43) Pub. Date: Feb. 16, 2017

(54) APPARATUS FOR CAPTURING AERIAL VIEW IMAGES

(71) Applicant: DRONES LATAM SRL, Montevideo (UY)

(72) Inventors: Alejandro RETTIG, Montevideo (UY); Ianai URWICZ, Montevideo (UY); German ZUCCOLI, Montevideo (UY)

(73) Assignee: DRONES LATAM SRL, Montevideo (UY)

(21) Appl. No.: 15/227,507

(22) Filed: Aug. 3, 2016

Related U.S. Application Data
(60) Provisional application No. 62/204,194, filed on Aug. 12, 2015.

(51) Int. Cl. B64D 47/08; B64C 39/02; B64D 17/02; H04N 5/225

(52) U.S. Cl. CPC B64D 47/08; H04N 5/2252; H04N 5/2253; B64C 39/02; B64D 17/02

(57) ABSTRACT

An apparatus for capturing aerial view images via an image capturing device is provided. The apparatus includes a base; a housing defining a cavity allowing for insertion of the image capturing device, wherein the housing is engaged with the base; at least one extension member, each extension member including an upper end and a lower end, wherein the lower end of each extension member is engaged with the base, wherein each extension member extends upwardly from the base; and an air resisting element engaged with the upper end of each extension member.

### CROSS-REFERENCE TO RELATED APPLICATIONS

This application claims the benefit of U.S. Provisional Patent Application No. 62/204,194 filed on Aug. 12, 2015, the contents of which are hereby incorporated by reference.

### TECHNICAL FIELD

The disclosure generally relates to an apparatus for capturing images from an aerial view, and more particularly to an apparatus used for launching a camera to an appropriate height for taking pictures or videos with an aerial view.

### BACKGROUND

The art of photography has significantly advanced in recent years. Cameras are becoming clearer, smaller, and more durable. Therefore, photographers are becoming more creative with their photography. This creativity has driven photographers to seek out new tools for taking photographs.

Professional photographers are no longer the only people with access to technology for capturing cutting-edge photographs. Because of the availability of low-cost photographic technologies, amateur photographers are also able to experiment with advanced cameras. Amateur photographers are interested in taking photos ranging from still art to self-photos (often referred to as “selfies”).

Unfortunately, current solutions are limited with respect to capturing aerial views. In particular, aerial selfies are difficult to obtain. Currently, a simple approach for taking an aerial selfie may require a photographer to manually operate a camera or set a camera timer and throw the camera in the air. These techniques restrict the taking of aerial photographs and, in the case of throwing the camera, expose the camera to risks of severe damage.

Other existing solutions for capturing aerial view images include piloting a drone or other small aircraft having a camera onboard. However, such aircrafts are typically somewhat expensive and often require a dedicated “pilot” (i.e., a person manning the aircraft or otherwise controlling an unmanned aircraft) throughout flight. Additionally, such aircrafts may be bulky and present challenges in transporting to and from locations of image capturing.

Therefore, it would be advantageous to provide a solution overcoming the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The embodiments disclosed herein include an apparatus for capturing aerial view images via an image capturing device. The apparatus includes a base; a housing defining a cavity allowing for insertion of the image capturing device, wherein the housing is engaged with the base; at least one extension member, each extension member including an upper end and a lower end, wherein the lower end of each extension member is engaged with the base, wherein each extension member extends upwardly from the base; and an air resisting element engaged with the upper end of each extension member.

The embodiments disclosed herein also include an apparatus for capturing aerial view images via an image capturing device. The apparatus includes a base defining a cavity for inserting at least the image capturing device; at least one extension member, each extension member including an upper end and a lower end, wherein the lower end of each extension member is engaged with the base, wherein each extension member extends upwardly from the base; and an air resisting element engaged with the upper end of each extension member.

### BRIEF DESCRIPTION OF THE DRAWINGS

The foregoing and other objects, features, and advantages of the disclosed embodiments will be apparent from the following detailed description taken in conjunction with the accompanying drawings.

FIG. 1A is a front view of an apparatus for capturing images with an aerial view according to an embodiment.

FIG. 1B is a top view of an apparatus for capturing images with an aerial view according to an embodiment.

FIG. 1C is a perspective view of an apparatus for capturing images with an aerial view according to an embodiment.

FIG. 1D is a bottom view of an apparatus for taking photographs and videos with an aerial view according to an embodiment.

FIG. 2 is a bottom side isometric view of the base of the apparatus according to an embodiment.

FIG. 3 is an isometric view illustrating a connection between the base and the top of the apparatus according to an embodiment.

FIG. 4 is an image illustrating front views of two apparatuses according to an embodiment.

FIG. 5 is an image illustrating deployment of the apparatus according to an embodiment.

FIG. 6 is an aerial view image of a user generated by a camera connected to the apparatus according to an embodiment.

FIG. 7 is a flowchart illustrating an example method for utilizing an apparatus for capturing images with an aerial view according to an embodiment.

FIGS. 8A and 8B are top left isometric views illustrating partial disassembly of an apparatus according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various example embodiments disclosed herein describe an apparatus configured to capture images such as pictures and videos from an aerial view. In an embodiment, the apparatus is configured for insertion of an image capturing device such as a camera. The apparatus is designed to position the capturing device in an optimal position to capture images in the air (e.g., the capturing device may be stable and facing downward). The apparatus lands without damaging the capturing device by allowing the user to catch the apparatus easily, or by protecting the capturing device in case it is not caught and falls onto the ground.

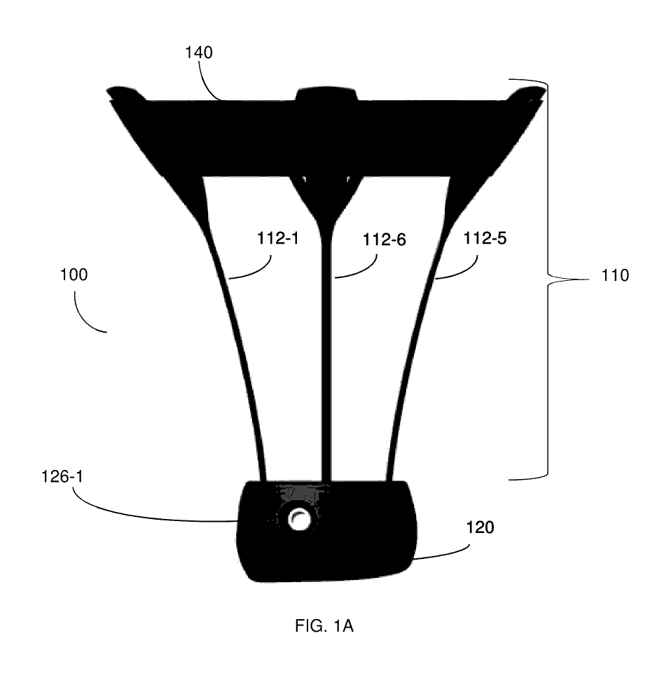

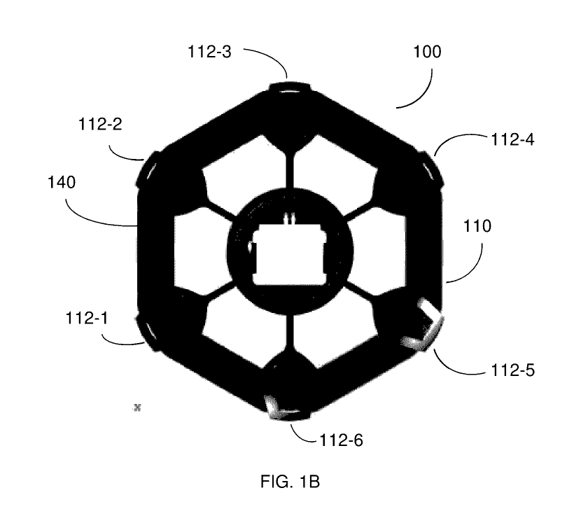

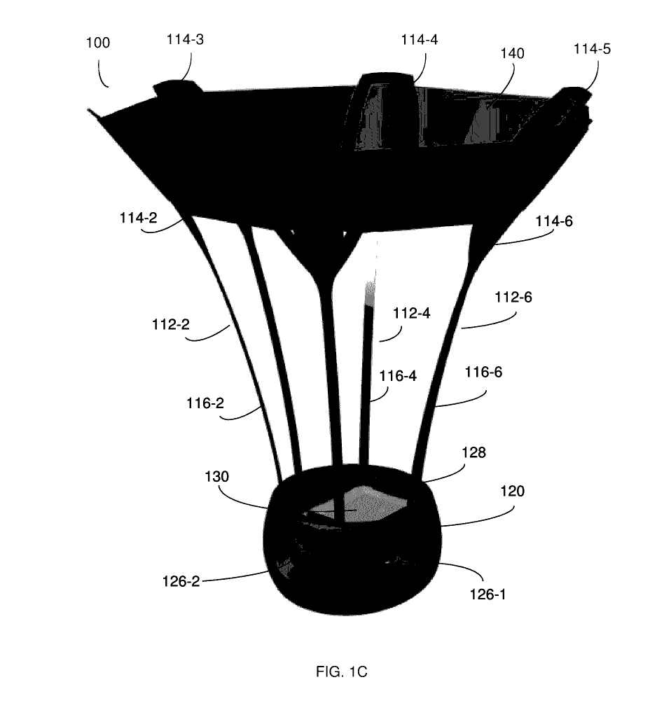

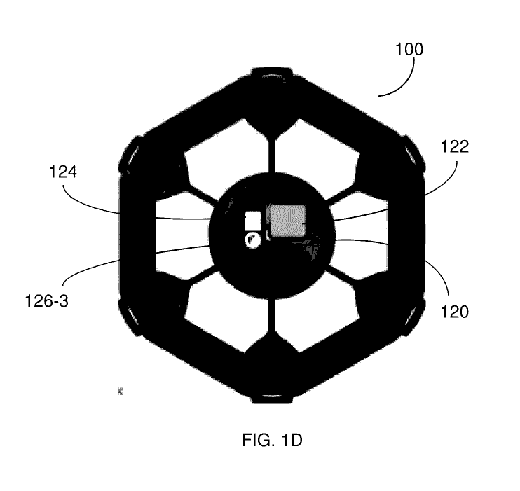

FIGS. 1A-1D are example views of an apparatus 100 for capturing images with an aerial view according to an embodiment. FIG. 1A is a front view, FIG. 1B is a top view, FIG. 1C is a perspective view, and FIG. 1D is a bottom view.

As seen in FIG. 1A, in an embodiment, the apparatus 100 includes a top portion 110 connected to a base 120. In a further embodiment, the top portion 110 includes an air resisting element such as an air resisting strip 140 and a plurality of extension members 112-1 through 112-6 (hereinafter referred to individually as an extension member 112 and collectively as extension members 112, merely for simplicity purposes), and the base 120 includes a housing 130 (seen in, e.g., FIG. 1C) for holding a camera or other image capturing device.

FIG. 1B is a top view of the apparatus 100 showing the top portion 110 including the plurality of extension members 112-1 through 112-6 as well as the air resisting strip 140. The air resisting strip 140 may be or may include a plurality of segments arranged so as to increase air resistance of the apparatus 100. As noted in FIG. 1C, each of the extension members 112 includes a corresponding upper end 114 and lower end 116 In an embodiment, the each of the lower ends 116 is configured to engage the base member 120, and each of the upper ends 114 is configured to engage the air resisting strip 140. As an example, as shown in FIG. 1C, the extension member 112-6 includes the lower end 116-6 engaged with the base 120 and the upper end 114-6 engaged with the air resisting strip 140.

In the example embodiment shown in FIGS. 1A-1D, the extension members 112 and the air resisting strip 140 form an approximately hexagonal shape. It should be noted that the extension members 112 may be arranged with the air resisting element 140 in other shapes without departing from the scope of the disclosure. In an embodiment, the air resisting strip may be or may include at least one strip of material such as, but not limited to, textile, fabric, leather, plastic, combinations thereof, and the like.

In a further embodiment, the extension members 112 extend at least partially upwardly from the top of the base 120 such that a perimeter formed by the upper ends 114 of the extension members 112 and the air resisting strip 140 (e.g., the perimeter of the hexagonal shape shown in FIG. 1B) is greater than a perimeter of the bottom of the base 120.

The extension members 112 extend at least partially upwardly from the base 120 and engage with the air resisting strip 140, thereby increasing the air resistance of the apparatus 100 and, accordingly, slowing the acceleration of the apparatus 100 as it descends to the ground. It should be recognized that decreasing the acceleration will soften the impact on the apparatus 100 as the apparatus 100 hits the ground. The extension members 112 may be removably engaged with the base 120 so as to allow for convenient disassembly and reassembly of the apparatus 100.

The top portion 110 further includes an air resisting strip 140 engaging the upper ends 114 of the extension members 112. The air resisting strip 140 is of a sufficient width to increase the air resistance of the apparatus 100 and, therefore, to slow the acceleration of the apparatus 100 as it descends to the ground. It should be recognized that decreasing the acceleration will soften the impact on the apparatus 100 as the apparatus 100 hits the ground. The air resisting strip 140 may further be removably engaged with the extension members 112 so as to allow for convenient disassembly and reassembly of the top portion 110.

The base 120 may include a housing 130 for allowing insertion of an image capturing device. The capturing device may be any device equipped with image capturing capabilities, video capturing capabilities, or a combination thereof. The capturing device may further be equipped with sound capturing capabilities. The capturing device may be or may include sensors such as, but not limited to, a camera, a microphone, a combination thereof, and the like. The capturing device may be or may be included in a device such as, but not limited to, a mobile phone, a smart phone, a tablet computer, a wearable computing device, and the like. The images captured by the capturing device may include any representation of an appearance and may be based on, but not limited to, light in the visible spectrum, light in other portions of the electromagnetic spectrum (e.g., infrared or X-rays), reflection of soundwaves, combinations thereof, and any other effects captured by sensors utilized for creating visual representations of appearances.

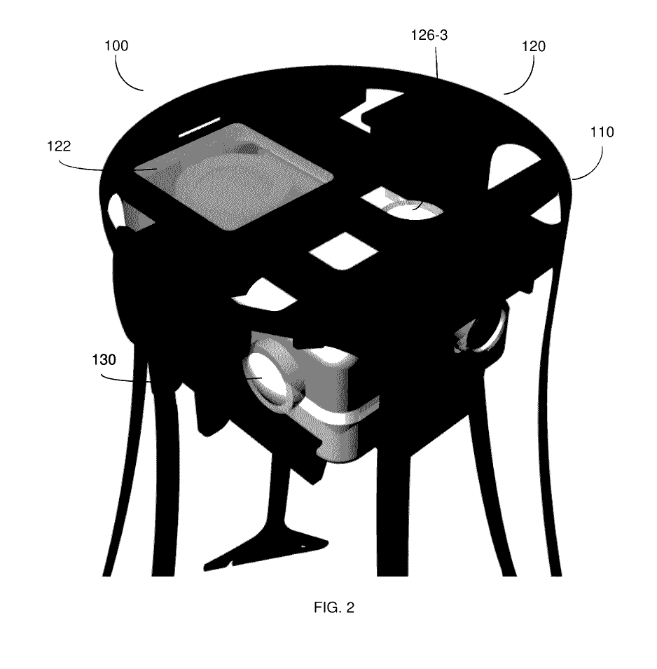

In an embodiment, the base 120 may be interchangeable to allow for substitution of, e.g., bases of different sizes, bases of different shapes, bases configured to receive different shapes or sizes of housings, or otherwise different configurations, appearances, or combinations thereof. In an embodiment, the housing 130 may be removably engaged with the base 120. In another embodiment, the housing 130 may be waterproof such that, when a capturing device is housed therein, the capturing does not become wet even if the apparatus 100 lands in water. The connection between the top portion 110 and the base 120 is explained in further detail herein below with respect to FIG. 2.

As illustrated in FIG. 1D, in an embodiment, the base 120 includes openings such as a window 122, an aperture 124, and button access cavities 126. The window 122 is an opening covered with a transparent material (e.g., clear plastic) through which a lens of the device housed in the housing 130 may capture at least one image. In a further embodiment, the window 122 may be disposed in the bottom of the base 120. The base 120 further includes an aperture 124 through which a flash of the device in the housing 130 may be transmitted. The aperture 124 may be situated in the bottom of the base 120.

The base 120 further includes at least one button access cavity 126 through which a user may engage the device housed in the housing 130. In the example embodiment shown in FIGS. 1A-1D, the base 120 includes 3 button access cavities 126-1 through 126-3 (hereinafter referred to individually as a button access cavity 126 and collectively as button access cavities 126, merely for simplicity purposes). A user may engage a device in the housing 130 via, for example, the device's scroll wheel, buttons, switches, or any other engagement mechanism of the device. The button access cavities 126 may be disposed in the bottom of the base 120, in a side wall of the base 120, or in a combination thereof. To this end, the housing 130 may further have disposed therein one or more cavities (not shown) for allowing a user to engage the device housed therein. Accordingly, the cavities in the housing 130 may be aligned with the button access cavities 126. In an embodiment, a user may engage a timer of the device via the button access cavities 126 to configure the device to capture images based on a delayed timing.

It should be noted that the embodiments described herein with respect to FIGS. 1A through 1D illustrate one window 122, one aperture 124, and one button access cavity 126-3 disposed in the bottom of the base 120 merely for example purposes and without limitation on the disclosed embodiments. Multiple windows, apertures, or button access cavities may be disposed in the bottom or in any other portion of the base 120 (e.g., the side, for example as demonstrated by the button access cavities 126-1 and 126-2 shown in FIG. 1C) without departing from the scope of the disclosure. The windows, apertures, and button access cavities may be further oriented horizontally, vertically, or at an angle with respect to the base 120 in the upright position.

The device may capture several images at predetermined time intervals during the flight of the apparatus 100. For example, the device may be configured to capture a picture every 0.5 seconds. As a further example, when thrown or otherwise launched upward, the device housed in the housing 130 of the apparatus 100 typically captures 10-12 pictures during the flight (i.e., between throwing or launching and landing). The device housed in the housing 130 may also be configured to capture video, sound, or a combination thereof.

In an embodiment, the device housed in the housing 130 may be an action camera. Action cameras are cameras configured to capture images of action while the camera is immersed in the action. An action camera may be compact, light, and rugged; may have waterproof surfaces; and may be capable of filming or taking pictures or videos in motion. Action images or videos in the location the image or video was taken. Examples of action cameras include, but are not limited to, GoPro® 3, 4, and 4 Session; SJ400/SJ5000+; and Xiaomi®.

In an embodiment, the base 120 may be weighted in such a manner as to ensure that the base 120 of the apparatus will land on, e.g., the ground, after the apparatus is thrown in the air. In another embodiment, the total weight of the apparatus 100 is light enough that, after securing any capturing device within the housing 130 of the base 120, the apparatus 100 will be weighted in such a manner as to ensure that the base 120 will land in the upright position after the apparatus 100 is thrown or otherwise launched into the air.

As shown in FIG. 1C, in an embodiment, the base 120 further includes at least one securing element 128. The securing element 128 engages with the housing 130 and the base 120, thereby securing the housing 130 to the base 120. The securing element 128 may include, but is not limited to, straps, locking mechanisms, snaps, clasps, male and female member combinations, screws, combinations thereof, and the like. It should be noted that the example securing elements noted above are not limiting, and that other elements for securing the housing 130 to the base 120, both currently existing and developed in the future, may be utilized without departing from the scope of the disclosure.

In an embodiment, the apparatus 100 includes electronic means, mechanical means, or a combination thereof (not shown) for engaging the device housed in the housing 130 during the flight of the apparatus 100. In an embodiment, such means may include an accelerometer. In a further embodiment, upon detecting that the apparatus 100 has reached a peak altitude via the accelerometer, the means for engaging the device may be configured to activate the device to capture at least one picture, video, sound, or combination thereof. It should be noted that the example embodiment described above is not limiting and that other means for engaging the device or otherwise causing the device to begin capturing videos, pictures, sounds, or combinations thereof, both currently existing and developed in the future, may be utilized without departing from the scope of the disclosure.

In an embodiment, an application on a user device may be employed to automatically set the device in the housing 130 with optimized settings for capturing pictures and videos. Such optimized settings may include, but are not limited to, resolution, compression, tint, brightness, color (e.g., black and white, greyscale, full color, etc.), aperture, and so on. The application may be further configured to download images, to filter the images, and to cause a display of the filtered images on a display of the user device. Filtering may include removing pictures or videos that are out of focus, retaining pictures and videos which depict people's faces, and the like. The app may also upload the filtered images to, for example, social networks.

It should be noted that the application can be executed by a processing system of the device in the housing 130 or by a processing system communicatively connected to the device in the housing 130. It should also be noted that the embodiments described herein with respect to FIG. 1 are discussed with regard to an apparatus including 6 extension members 112 merely for simplicity purposes and without limitation on the disclosed embodiments. Other numbers of extension members may be equally utilized without departing from the scope of the disclosure.

FIG. 2 is an example bottom side isometric view of the base 120 of the apparatus 100 according to an embodiment. In FIG. 2, the capturing device (not shown) housed in the housing 130 may be seen in the base 120 with a window 122 allowing the device to capture pictures, videos, or a combination thereof through the bottom of the base 120. Further, the button access 126 allows a user to engage the device through the base 120.

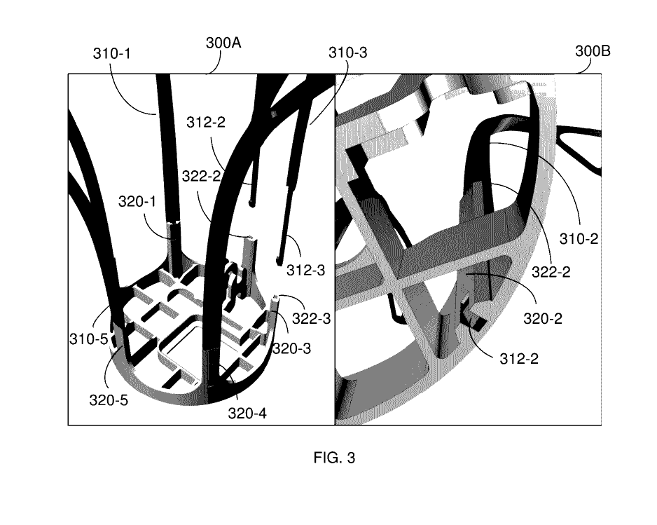

FIG. 3 is an example top isometric view 300A and an example bottom isometric view 300B illustrating a wing snap connection of the apparatus 100 according to an embodiment. The wing snap connection connects the top portion 110 to the base 120. In an embodiment, the wing snap connection includes a plurality of snaps 310-1 through 310-6 (hereinafter referred to individually as a snap 310 and collectively as snaps 310, merely for simplicity purposes) and a plurality of wings 320-1 through 320-6 (hereinafter referred to individually as a wing 320 and collectively as wings 320, merely for simplicity purposes).

In an embodiment, each of the snaps 310 is located on the lower portion 114 of one of the extension members 112 of the top portion 110. Each snap 310 is configured to fit inside one of the wings 320. Each snap 310 includes a protruding segment 312 which is configured to catch the bottom edge of the wing 320 in order to lock the top portion 110 and the base 120 in place.

Each of the wings 320 protrudes upward from the base 120. In an embodiment, there is a corresponding wing 320 for each snap 310. The wing 320 further includes an inner hollow shaft 322 configured to accept a snap 310.

In an embodiment, to disengage the wing snap connection 300, a user may push the protruding segment 312 towards the outer edge of the apparatus 100 to allow the snap 310 to move upwards through the shaft 322.

It should be noted that the embodiments described herein with respect to FIG. 3 are discussed with respect to a wing snap connection merely for example purposes and without limitation on the disclosed embodiments. In various embodiments, the apparatus 100 may include a securing element other than the snap 310 (not shown) securing the wing 320 to the base 120, for example, as described further herein above with respect to FIG. 1.

It should be noted that the embodiments described herein above with respect to FIG. 3 are discussed as including 6 snaps 310 and 6 wings 320 merely for example purposes and without limitation on the disclosure. Other numbers of snaps, wings, or both may be utilized without departing from the scope of the disclosed embodiments.

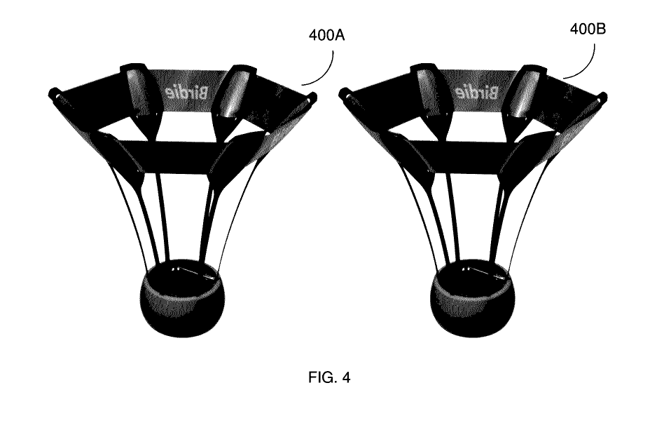

FIG. 4 is an example image depicting a front isometric view of two apparatuses 400A and 400B, respectively, according to an embodiment.

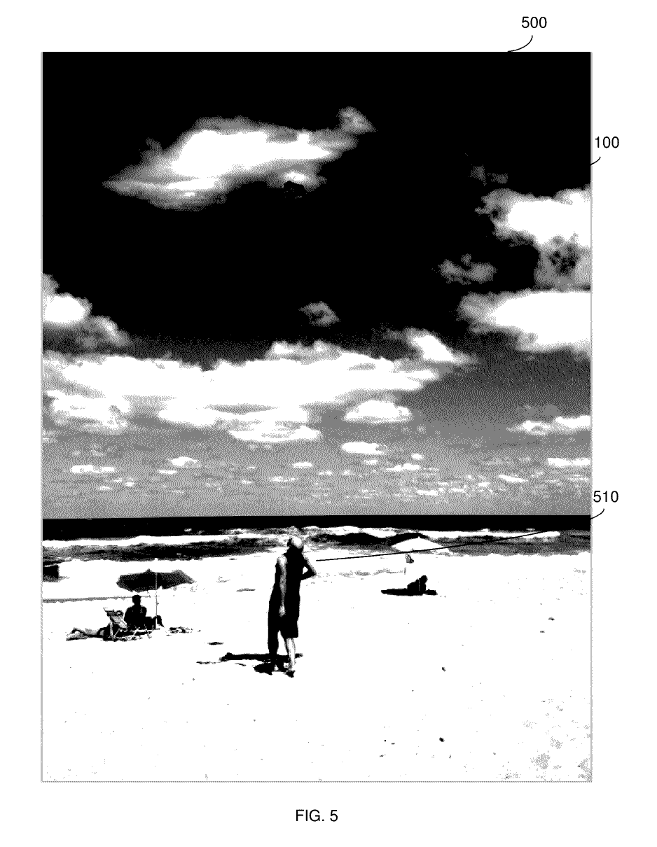

FIG. 5 is an example image 500 illustrating deployment of the apparatus 100 by a user 510. The user 510 may secure a camera (e.g., the capturing device housed in the housing 130) within the apparatus 100. Once the capturing device is secured, the user 510 engages a timing mechanism of the capturing device to take a time delayed picture, a series of pictures, or a video. Alternatively, the user 510 sets the timing mechanism before securing the capturing device in the apparatus 100. The user 510 may then throw the apparatus 100 into the air as depicted in FIG. 5. The descent of the apparatus 100 is slowed by extension members (e.g., the extension members 112) and an air resisting strip (e.g., the air resisting strip 114) on the apparatus 100. In an example embodiment, the user may throw the apparatus 100 by grasping and throwing a base (e.g., the base 120), one or more extension members (e.g., the extension members 112), a housing for a capturing device (e.g., the housing 130), or any other part of the apparatus 100.

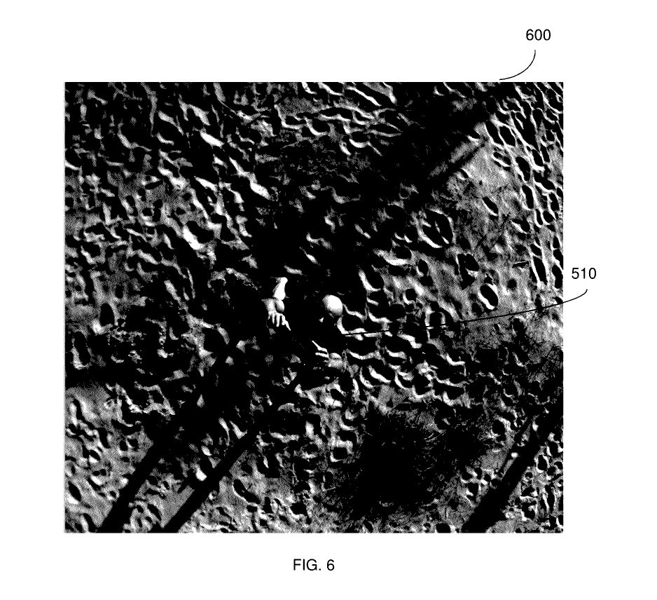

FIG. 6 is an example aerial view image 600 of the user 510 generated by a camera connected to the apparatus 100 (camera and apparatus 100 not shown in FIG. 6). The aerial view image 600 may be a sole image taken at a time set via a timing mechanism of the apparatus 100, or may be one of a series of images taken throughout the flight of the apparatus 100 (i.e., after being thrown but before landing).

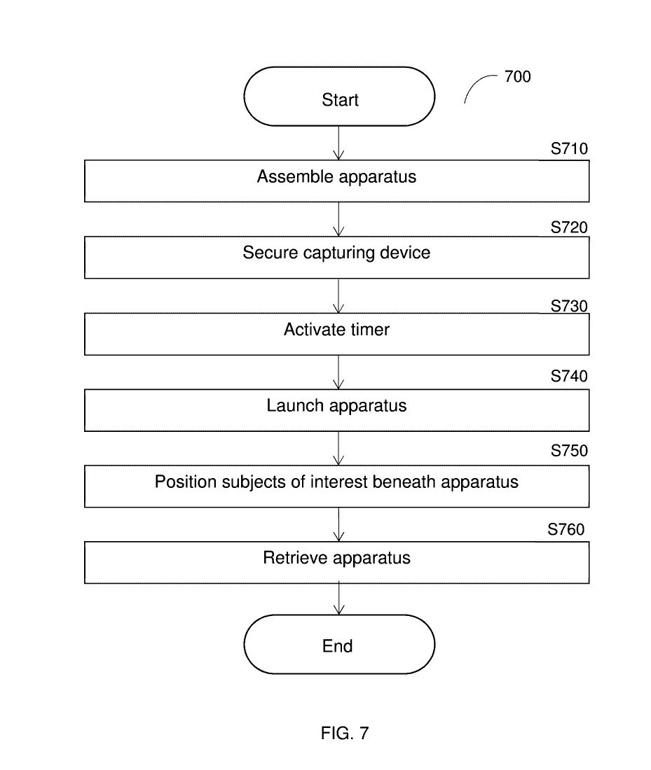

FIG. 7 is an example flowchart 700 illustrating a method for utilizing the apparatus 100 for capturing at least one image having an aerial view using the apparatus 100 according to an embodiment. The at least one image may include, but is not limited to, a picture, a series of pictures, a video, a combination thereof, and the like.

At optional S710, the apparatus 100 is assembled. The assembly may include assembling all components of the apparatus 100 that are readily removable. As a non-limiting example, the apparatus 100 may be assembled from components including the base 120, the housing 130, the extension members 112, and the air resisting strip 140. Assembling the apparatus 100 may include, but is not limited to, engaging the lower end 116 of each extension member 112 with a corresponding securing element 128 of the base 120, engaging the air resisting strip 140 with the upper end 114 of each extension member 112, inserting the housing 130 into the base 120, a combination thereof, and the like.

At S720, a camera or other capturing device is secured by a user in the housing 130 of the base 120 of the apparatus 100. The camera may be secured by the securing element 128. The securing element 128 may include, but is not limited to, straps, a locking mechanism, snaps, clasps, and the like. It should be noted that the method is described with respect to a camera merely for simplicity purposes.

At S720, a timer of the camera is activated by the user. The timer may be engaged through the at least one button access 126. The timer is set for an appropriate amount of time to capture at least one image while the apparatus 100 is airborne. In an embodiment, the timer may be activated prior to securing the camera in the housing 130 of the apparatus 100.

At S730, the apparatus 100 is thrown into the air by the user. In an embodiment, the user throws the apparatus 100 directly upward, orienting the base 120 of the apparatus 100 towards the sky. In an alternative embodiment, the user throws the apparatus 100 in a parabolic direction to, e.g., another user of some distance away from the first user. As the apparatus 100 reaches its peak height, the weight of the base 120, or the combination of the weight of the camera 130 and the base 120, causes the apparatus 100 to reorient itself in midair, resulting in the base 120 facing the ground.

At optional S740, subjects of interest for the aerial images are positioned under the apparatus 100. The subjects may include, for example, the user, other people, pets, environmental effects (e.g., a field, a pool, an ocean, rocks, wild animals, combinations thereof, portions thereof, etc.), combinations thereof, and the like. In an embodiment, the user and other subjects of interest for the aerial selfie assemble a pose before the timer runs out and the camera captures a picture.

At S750, the apparatus 100 is retrieved. The user may catch the apparatus 100 before the apparatus 100 hits the ground. Alternatively, the user may allow the apparatus 100 to hit the ground without interfering with the flight of the apparatus 100. The extension members 112 and the air resisting strip 140 decrease the acceleration of the apparatus 100 as it descends, thereby minimizing the impact received by the apparatus 100 and protecting the camera in the housing 130. The camera is further protected by the base 120 and the securing element 128.

As a non-limiting example, a user assembles the base 120 including the housing 130, the extension members 112, and the air resisting strip 140 into the apparatus 100. The user sets a GoPro® camera in the housing 130 and sets a timing of the camera through the button activation cavity 126 in the base 120. The user launching the apparatus 100 into the air by gripping the extension members 112 together and throwing the apparatus 100 by releasing the gripped extension members 112 while making a throwing motion. The user and three friends stand together beneath the thrown apparatus 100. The apparatus 100 captures an aerial picture of the four friends before falling to the ground. The user retrieves the apparatus 100.

It should be noted that the embodiment describe above with respect to FIG. 7 is merely an example use of the apparatus 100 and does not limit any of the disclosed embodiments. It should be further noted that the embodiment of FIG. 7 is described with respect to a user merely for simplicity purposes and without limitation on the disclosed embodiments. The method may be performed by multiple users without departing from the disclosed embodiments. For example, one user may activate the timer of the camera before handing the apparatus to another user for throwing.

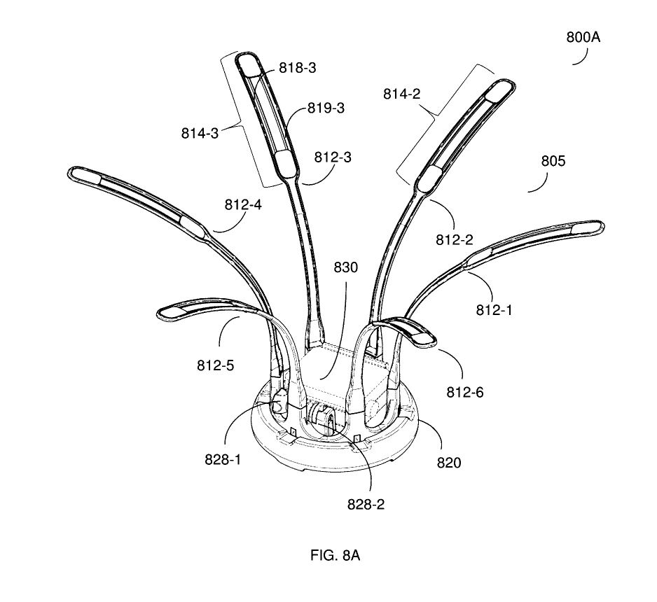

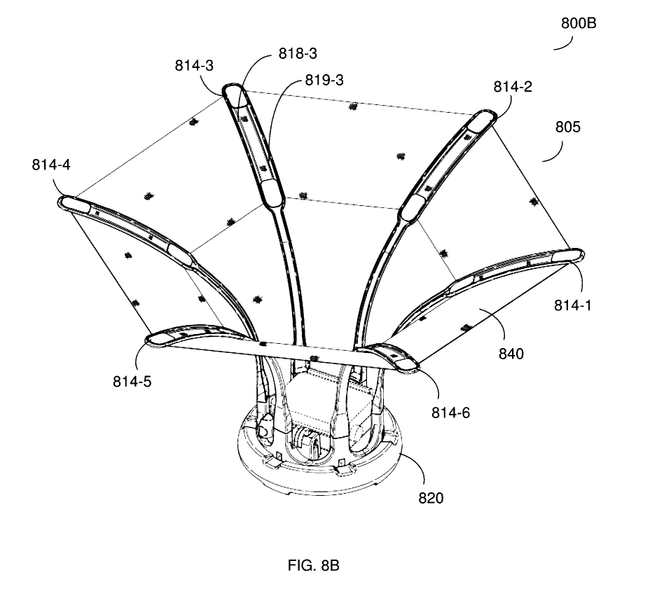

FIGS. 8A and 8B are top left isometric views 800A and 800B illustrating partial disassembly of an apparatus 805 according to an embodiment. Specifically, the view 800A illustrates the apparatus 805 without an air resisting element. The apparatus 805 includes a base 820 engaged with a plurality of extension members 812-1 through 812-6, a housing 130 configured for placement of a camera, and securing elements 828-1 and 828-2. In the view 800A, each of the extension members 812-1 through 812-6 is an arm engaged with and extending upward from the base 820. Further, in an example embodiment, the extension members 812-1 through 812-6 may each be removably engaged such that a user can remove the extension member 812 by simply pulling each extension member 812 from a corresponding portion of the base 820.

In the example embodiment shown in FIG. 8A, each of the extension members 812-1 through 812-6 has an upper end 814 (e.g., the upper ends 814-2 and 814-3 of extension members 812-2 and 812-3, respectively). Each upper end 814 further defines at least one opening. Specifically, in the embodiment shown in FIG. 8A, each upper end includes a first opening 818 and a second opening 819 (e.g., the first opening 818-3 and the second opening 819-3 of the upper end 814-3 of the extension member 812-3 illustrated in FIG. 8A).

In the example embodiment shown in FIG. 8A, the securing elements 828-1 and 828-2 are a screw and a threaded fastener, respectively. During assembly, a camera housing 830 housing a camera may be placed in the base 120, and the screw securing element 828-1 may be screwed into the threaded fastener securing element 828-2 through at least a portion of the camera housing 830. Such securing allows the camera housing 830 to be removable from the base 820 and, consequently, the apparatus 805.

The view 800B illustrates the apparatus 805 including an air resisting element 840 engaged with upper ends 814-1 through 814-6 of the extension members 812-1 through 812-6, respectively. In the example embodiment shown in FIG. 8B, the air resisting element 840 is a strip of fabric threaded through the first opening 818 and the second opening 819 each of the upper ends 814-1 through 814-6.

It should be further noted that the embodiments disclosed herein are not limited to the particular structures described herein. For example, but without limitation, different apparatuses having different numbers of extension members, securing elements, shapes, and the like may be utilized without departing from the scope of the disclosure. The method described with respect to FIG. 7 may be utilized for any such apparatus variation.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

A portion of the disclosure of this patent document contains material which is subject to copyright protection. The copyright owner has no objection to facsimile reproduction by anyone of the patent document or the patent disclosure, as it appears in the Patent & Trademark Office patent file or records, but otherwise reserves all copyright rights whatsoever.

What is claimed is:

1. An apparatus for capturing aerial view images via an image capturing device, comprising:
a base;
a housing defining a cavity allowing for insertion of the image capturing device, wherein the housing is engaged with the base;
at least one extension member, each extension member including an upper end and a lower end, wherein the lower end of each extension member is engaged with the base, wherein each extension member extends upwardly from the base; and
an air resisting element engaged with the upper end of each extension member.

2. The apparatus of claim 1, wherein the housing is removably engaged with the base.

3. The apparatus of claim 2, wherein the at least one extension member is removably engaged with the base.

4. The apparatus of claim 3, wherein the air resisting element is removably engaged with each of the at least one extension member.

5. The apparatus of claim 1, wherein the air resisting element includes at least one strip.

6. The apparatus of claim 5, the upper end of each of the at least one extension member defining at least one opening, wherein the air resisting element is threaded through each opening defined in the at least one extension member.

7. The apparatus of claim 1, the base defining at least one aperture, wherein the image capturing device has at least one sensor, wherein each sensor of the image capturing device is aligned with one of the at least one aperture defined in the base when the image capturing device is inserted into the housing engaged with the base.

8. The apparatus of claim 7, the base including a transparent element, wherein the at least one aperture defined in the base includes a window, wherein the transparent element covers at least the window.

9. The apparatus of claim 1, the base further including at least one securing element, the at least one securing element engaging the housing.

10. The apparatus of claim 9, wherein the at least one securing element is a threaded fastener defining a cavity, the housing defining at least one hole, wherein the at least one hole defined in the housing is aligned with the cavity of the threaded fastener, further comprising:
a screw, wherein the screw is engaged with the threaded fastener, wherein at least a part of the screw is disposed in each of the at least one hole defined in the housing.

11. An apparatus for capturing aerial view images via an image capturing device, comprising:
a base defining a cavity for inserting at least the image capturing device;
at least one extension member, each extension member including an upper end and a lower end, wherein the lower end of each extension member is engaged with the base, wherein each extension member extends upwardly from the base; and
an air resisting element engaged with the upper end of each extension member.

12. The apparatus of claim 11, further comprising:
a housing for allowing insertion of the image capturing device, wherein the housing is disposed in the cavity of the base, wherein the housing is removably engaged with the base.

13. The apparatus of claim 11, wherein the at least one extension member is removably engaged with the base.

14. The apparatus of claim 13, wherein the air resisting element is removably engaged with each of the at least one extension member.

15. The apparatus of claim 11, wherein the air resisting element includes at least one strip.

16. The apparatus of claim 15, the upper end of each of the at least one extension member defining at least one opening, wherein the air resisting element is threaded through each opening defined in the at least one extension member.

17. The apparatus of claim 11, the base defining at least one aperture, wherein the image capturing device has at least one sensor, wherein each sensor of the image capturing device is aligned with one of the at least one aperture defined in the base when the image capturing device is inserted into the cavity defined in the base.

18. The apparatus of claim 17, the base including a transparent element, wherein the at least one aperture defined in the base includes a window, wherein the transparent element covers at least the window.

19. The apparatus of claim 11, the base further including at least one securing element for engaging an image capturing device housing.
